(19) United States
(12) Patent Application Publication
(10) Pub. No.: US 2019/0311617 A1
(43) Pub. Date: Oct. 10, 2019

(54) ELECTRONIC DEVICE AND METHOD FOR MONITORING A ROAD INTERSECTION ZONE FOR AUTONOMOUS MOTOR VEHICLE(S), RELATED COMPUTER PROGRAM

(71) Applicant: TRANSDEV GROUP, Issy Les Moulineaux (FR)

(72) Inventor: Cem KARAOGUZ, PALAISEAU (FR)

(21) Appl. No.: 16/379,306

(22) Filed: Apr. 9, 2019

(30) Foreign Application Priority Data
Apr. 10, 2018 (FR) 18 53096

(51) Int. Cl. G08G 1/01; G08G 1/0967; G05D 1/02; G05D 1/00

(52) U.S. Cl. CPC G08G 1/0145; G08G 1/0116; G05D 2201/0213; G05D 1/0276; G05D 1/0088; G08G 1/096725

(57) ABSTRACT

An electronic device for monitoring a road intersection zone includes a detection module configured to detect, via at least one sensor, at least one traffic element entering the road intersection zone, each sensor being able to be connected to the detection module and being arranged on-street near the road intersection zone. The device further includes a calculating module configured to calculate at least one access indicator associated with the road intersection zone as a function of the detection of traffic element(s) entering the road intersection zone, and a transmission module configured to send at least one calculated indicator to an autonomous motor vehicle approaching the road intersection zone.

### CROSS-REFERENCE TO RELATED APPLICATIONS

This application is a U.S. non-provisional application claiming the benefit of French Application No. 18 53096, filed on Apr. 10, 2018, which is incorporated herein by reference in its entirety.

### FIELD OF THE INVENTION

The present invention relates to an electronic device for monitoring a road intersection zone.

The invention also relates to a method for monitoring a road intersection zone, the method being carried out by an electronic monitoring device.

The invention also relates to a non-transitory computer-readable medium comprising a computer program including software instructions which, when executed by a computer, implement such a monitoring method.

The invention relates to the field of autonomous motor vehicles, in particular autonomous motor vehicles having a level of automation greater than or equal to 3 on the scale of the International Organization of Motor Vehicle Manufacturers, also called OICA (Organisation Internationale des Constructeurs Automobiles). Autonomous motor vehicles are in particular transport vehicles, such as taxis, shuttles, buses or coaches.

### BACKGROUND OF THE INVENTION

Traditionally, an autonomous motor vehicle, in particular an autonomous motor vehicle having a level of automation equal to 3, 4 or 5 on the OICA scale, is equipped with a plurality of sensors and one or several computers coupled to these sensors, for example to allow the autonomous vehicle to position itself on the road and adjust its speed based on automobile traffic, in order to avoid a collision with another vehicle or an obstacle, to detect a change in trajectory or to perform a parking maneuver.

However, the crossing of a road intersection zone by such an autonomous vehicle remains relatively risky, and then requires complex calculations to limit the collision risks of the autonomous vehicle with another vehicle or an obstacle in the road intersection zone.

### SUMMARY OF THE INVENTION

The aim of the invention is then to propose an electronic device and an associated method for monitoring a road intersection zone intended for autonomous motor vehicle(s), intended to further limit the collision risks inside the road intersection zone, while requiring less complex calculations.

To that end, the invention relates to an electronic device for monitoring a road intersection zone, the device comprising:

a detection module configured to detect, via at least one sensor, at least one traffic element entering the road intersection zone, each sensor being able to be connected to the detection module and being arranged on-street near said road intersection zone,

a calculating module configured to calculate at least one access indicator associated with the road intersection zone as a function of the detection of traffic element(s) entering the road intersection zone, and

a transmission module configured to send at least one calculated indicator to an autonomous motor vehicle approaching the road intersection zone.

Thus, the electronic monitoring device according to the invention makes it possible to detect, via at least one sensor arranged on-street near said road intersection zone, each traffic element entering the road intersection zone, then to calculate one or several access indicators associated with the road intersection zone as a function of the detection or non-detection of traffic element(s) entering the road intersection zone, and to send at least one calculated indicator to an autonomous motor vehicle approaching the road intersection zone.

The autonomous vehicle approaching said road intersection zone is then authorized to enter said road intersection zone only if it has received a respective access indicator having an authorized access value. In other words, and conversely, each autonomous vehicle approaching the road intersection zone stops before entering said road intersection zone, once it receives an access indicator having the prohibited access value.

According to other advantageous aspects of the invention, the electronic monitoring device comprises one or more of the following features, considered alone or according to all technically possible combinations:

the calculating module is configured to position each access indicator at an authorized access value as long as no traffic element entering the road intersection zone is detected;

the road intersection zone comprises several access paths, and each access path for motor vehicle(s), in particular for autonomous motor vehicle(s), is associated with a predefined entry limit into the road intersection zone, and the calculating module is configured to calculate an access indicator for each entry limit;

the calculating module is configured to position, at a prohibited access value, an access indicator associated with an entry limit of a respective path upon detection of a traffic element positioned inside a detection zone associated with a path secant to said respective path;

the detection zone associated with a path is a predefined path in 2 or 3 dimensions,

preferably in the shape of a polygon;

the transmission module is configured to group together the set of calculated indicator(s) in a common file and to broadcast said common file to the autonomous motor vehicle(s) approaching the road intersection zone;

each access indicator has a value chosen from the group consisting of: access prohibited, access authorized, access authorized with a specific speed limitation, access authorized with indication of a potential danger; and

each autonomous motor vehicle has a level of automation greater than or equal to 3 on the scale of the International Organization of Motor Vehicle Manufacturers.

The invention also relates to a method for monitoring a road intersection zone, the method being carried out by an electronic monitoring device and comprising:

the detection, via at least one sensor, of at least one traffic element entering the road intersection zone, each sensor being able to be connected to the detection module and being arranged on-street near said road intersection zone,

the calculation of at least one access indicator associated with the road intersection zone as a function of the detection of traffic element(s) entering the road intersection zone, and

the transmission of at least one calculated indicator to an autonomous motor vehicle approaching the road intersection zone.

The invention also relates to a non-transitory computer-readable medium comprising a computer program including software instructions which, when executed by a computer, implement a monitoring method as defined above.

### BRIEF DESCRIPTION OF THE DRAWINGS

These features and advantages of the invention will appear more clearly upon reading the following description, provided solely as a non-limiting example, and done in reference to the appended drawings, in which:

FIG. 1 is a schematic illustration of an electronic monitoring device according to the invention, configured to monitor a road intersection zone,

FIG. 2 is a view similar to that of FIG. 1 according to another example road intersection zone,

FIG. 3 is an organizational chart of a method according to the invention for monitoring the road intersection zone, the method being implemented by the electronic monitoring device of FIG. 1, and comprising a step for detecting at least one traffic element entering the road intersection zone, a step for calculating at least one access indicator associated with the road intersection zone as a function of the detection or non-detection of traffic element(s) entering said road intersection zone, and a step for sending at least one calculated indicator to an autonomous motor vehicle approaching the road intersection zone, and

FIG. 4 is a flowchart showing the step for calculating at least one access indicator, of the monitoring method of FIG. 3.

### DESCRIPTION OF THE PREFERRED EMBODIMENTS

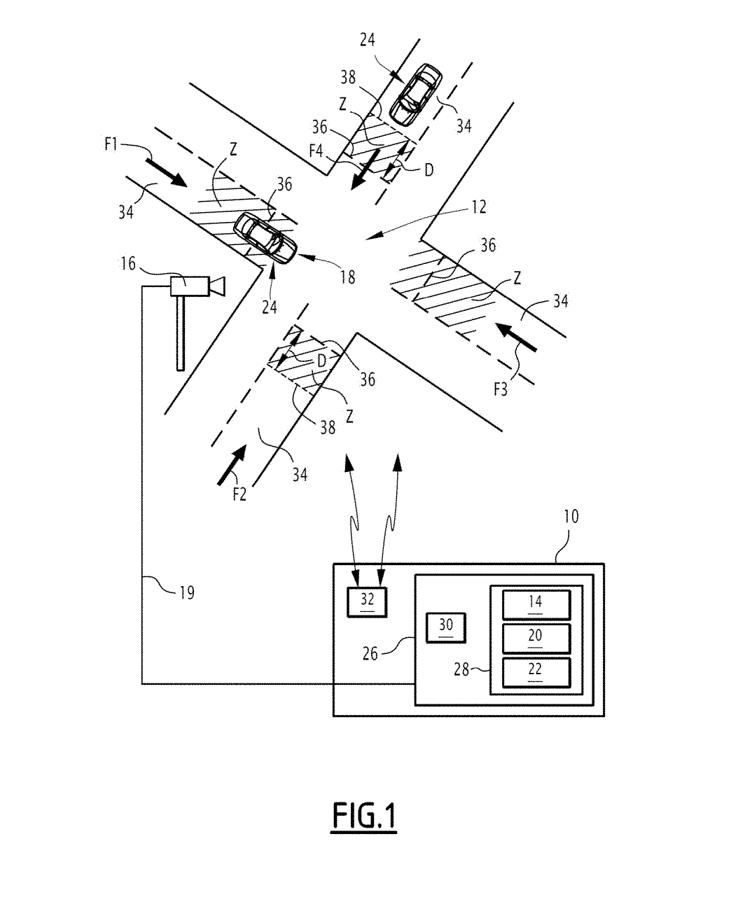

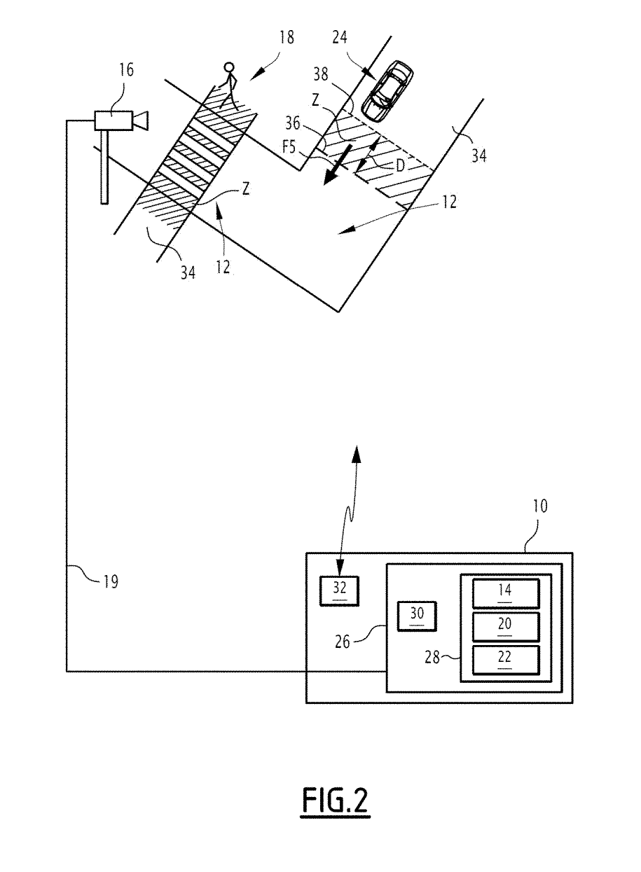

In FIGS. 1 and 2, an electronic monitoring device 10 is configured to monitor a road intersection zone 12. The electronic monitoring device 10 comprises a detection module 14 configured to detect, via at least one sensor 16, at least one traffic element 18 entering the road intersection zone 12, each sensor 16 being connected to the detection module 14, via a wired connection 19, as illustrated in the examples of FIGS. 1 and 2, or via a wireless connection, not shown, such as a radio link. Each sensor 16 is arranged on-street near said road intersection zone 12.

The electronic monitoring device 10 further comprises a calculating module 20 configured to calculate at least one access indicator associated with the road intersection zone 12 as a function of the detection or non-detection of traffic element(s) 18 entering the road intersection zone 12.

The electronic monitoring device 10 also comprises a transmission module 22 configured to send at least one calculated indicator to an autonomous motor vehicle 24 approaching the road intersection zone 12.

In the example of FIGS. 1 and 2, the electronic monitoring device 10 comprises an information processing unit 26, for example made up of a memory 28 and a processor 30 associated with the memory 28. The electronic monitoring device 10 comprises a transceiver 32, in particular configured to emit, in the form of radio waves, the data sent by the transmission module 22 to autonomous vehicle(s) 24 approaching the road intersection zone 12.

The road intersection zone 12 comprises several access paths 34. Each access path 34 is a circulation path, i.e., a path allowing the circulation of a traffic element 18, in particular a motor vehicle, such as an autonomous motor vehicle 24, like in the example of FIG. 1, or of a pedestrian, like in the example of FIG. 2, and making it possible to access the road intersection zone 12, i.e., to enter said zone 12. Each access path 34 for motor vehicle(s), in particular for autonomous motor vehicle(s) 24, is associated with a predefined entry limit 36 into the road intersection zone 12.

In the example of FIG. 1, the road intersection zone 12 comprises four access paths 34, the paths in this example being circulation paths for motor vehicle(s). The road intersection zone 12 is, in this example, crossed through by the four access paths 34.

In the example of FIG. 2, the road intersection zone 12 comprises two access paths 34, namely a circulation path for motor vehicle(s) and a circulation path for pedestrian(s), also called crosswalk. In this example of FIG. 2, a predefined entry limit 36 is associated with the motor vehicle access path 34, while the pedestrian access path 34 has no predefined entry limit.

Each access path 34, whether it is a motor vehicle or pedestrian path, is associated with a detection zone Z for detecting traffic element(s) 18. The detection zone Z is a zone in which a traffic element 18 can be detected by the detection module 14 as a traffic element 18 entering the road intersection zone 12.

The detection zone Z associated with the path 34 is a zone of predefined shape with 2 dimensions in a plane of the path 34, or 3 dimensions further taking into account a height along a direction perpendicular to said plane.

The detection zone Z is for example in the shape of a polygon in 2 or 3 dimensions, the coordinates of the apices of which are predefined, as illustrated with the paths 34 associated with the arrows F1 and F3 in FIG. 1 with the pedestrian path 34 in FIG. 2.

Alternatively, the detection zone Z associated with a path 34 is a portion of said path 34 situated between the entry limit 36 and a predefined distance D upstream from said entry limit 36, the traffic element 18 circulating from upstream to downstream on said path 34, as illustrated with the paths 34 associated with the arrows F2 and F4 in FIG. 1 or with the path 34 associated with the arrow F5 in FIG. 2. One skilled in the art will further observe that said arrows F1 to F5 further depict the direction of traffic, from upstream to downstream, in the corresponding path 34.

In the example of FIGS. 1 and 2, the detection module 14, the calculating module 20 and the transmission module 22 are each made in the form of software, or a software module, executable by the processor 30. The memory 28 of the electronic monitoring device 10 is then able to store detection software for detecting, via at least one sensor 16, at least one traffic element 18 entering the road intersection zone 12, calculating software configured to calculate at least one access indicator associated with the road intersection zone 12 as a function of the detection or non-detection of traffic element(s) 18 entering the road intersection 12 and transmission software configured to send at least one calculated indicator to an autonomous motor vehicle 24 approaching the road intersection zone 12. The processor 30 is then able to execute each of the software applications from among the detection software, the calculating software and the transmission software.

In an alternative that is not shown, the detection module 14, the calculating module 20 and the transmission module 22 are each made in the form of a programmable logic component, such as an FPGA (Field Programmable Gate Array), or in the form of a dedicated integrated circuit, such as an ASIC (Application Specific Integrated Circuit).

When the electronic monitoring device 10 is made in the form of one or several software programs, i.e., in the form of a computer program, it is further able to be stored on a medium, not shown, readable by computer. The computer-readable medium is for example a medium suitable for storing electronic instructions and able to be coupled with a bus of a computer system. As an example, the readable medium is an optical disc, a magnetic-optical disc, a ROM memory, a RAM memory, any type of non-volatile memory (for example, EPROM, EEPROM, FLASH, NVRAM), a magnetic card or an optical card. A computer program including software instructions is then stored on the readable medium.

In the example of FIGS. 1 and 2, the detection module 14, the calculating module 20 and the transmission module 22 are on board within the information processing module 26, i.e., within a single and same electronic computer.

In a variant, not shown, the detection module 14 on the one hand, and the calculating module 20 and the transmission module 22 on the other hand, are on board within two distinct and separate electronic computers.

According to this variant, the electronic detection module 14 is for example arranged near the sensor(s) 16, while being connected to each of the sensors 16, by a wired connection 19 or radio link. As an optional addition, the detection module 14 is for example integrated into a corresponding sensor 16.

According to this variant, the calculating module 20 and the transmission module 22 are then for example arranged within a supervision computer, positioned further from the sensor(s) 16. The supervision computer is for example a platform of a control center. As an optional addition, the supervision computer is connected to several detection modules 14, and the calculation of the access indicator(s) is then done as a function of the traffic element(s) entering the road intersection zone 12, detected by the set of detection modules 14.

Additionally, the transmission module 22 is also configured to transmit, to the autonomous motor vehicle 24 approaching the road intersection zone 12, an access indicator having a forced value, for example manually by an operator, instead of the access indicator calculated by the calculating module 20.

The detection module 14 is for example configured to detect a traffic element 18 entering the road intersection zone 12, once the sensor 16 identifies a traffic element 18 positioned inside the detection zone Z associated with said path 34.

When the detection zone Z is the portion of said path 34 situated between the entry limit 36 and the distance D upstream from said entry limit 36, this distance D is for example predefined respectively for each access path 34, and is then able to vary from one access path 34 to the other. In a variant, the distance D is identical for all of the access paths 34 of the road intersection zone 12.

In the example of FIGS. 1 and 2, a single sensor 16 is associated with the road intersection zone 12, this single sensor 16 supervising the entire road intersection zone 12 and then being able to detect a traffic element 18 traveling over any path 34 inside the road intersection zone 12, in particular inside a respective detection zone Z.

In a variant that is not shown, a plurality of sensors 16 is associated with the road intersection zone 12.

Each sensor 16 is arranged on-street near said road intersection zone 12. Each sensor 16 is for example arranged along an access path 34, or on the road forming said access path 34.

Each sensor 16 is for example chosen from among a group consisting of: a video camera in the visible domain, an infrared camera, a LIDAR, a radar and a sensor integrated into the road, such as an electromagnetic sensor, an ultrasound sensor, or a sensor with double detection, electromagnetic and ultrasound.

In the example of FIGS. 1 and 2, the sensor 16 is a video camera in visible domain, the field of view (FOV) of which covers the entire road intersection zone 12.

One skilled in the art will understand in general that when the sensor 16 is a camera, the latter is chosen and positioned such that the entire road intersection zone 12 is covered by the field(s) of the camera(s). Similarly, when the sensor 16 is a LIDAR or a radar, the number of sensors 16 is chosen in line with the number of access paths 34, and the sensors 16 are positioned, as is known in itself, so as to cover the entire road intersection zone 12, in particular each detection zone Z. Also similarly, when the sensor 16 is a sensor integrated into the road, such as a magnetometer, an electromagnetic sensor, an ultrasound sensor or a sensor with double detection combining electromagnetic detection and ultrasound detection, a respective sensor 16 is associated with each detection zone Z.

Each sensor 16 is then able to identify one or several traffic elements located in a respective detection Z for access path 34. Each sensor 16 is further able, for each identified traffic element 18, to determine a position of said traffic element 18, such as its instantaneous position, and to measure a speed of said traffic element 18, such as its instantaneous speed.

Each traffic element 18 is an element able to travel and/or traverse a respective path 34. Each traffic element 18 is in particular an element able to be located in a respective detection zone Z.

Each traffic element 18 is for example chosen from among the group consisting of: a motorized vehicle, a non-motorized vehicle, a pedestrian and an animal.

The calculating module 20 is configured to calculate at least one access indicator associated with the road intersection zone 12 as a function of the detection or non-detection, by the detection module 14, of traffic element(s) 18 entering the road intersection zone 12.

The calculating module 20 is for example configured to position each access indicator at an authorized access value as long as no traffic element 18 entering the road intersection zone 12 is detected by the detection module 14.

The calculating module 20 is for example configured to calculate an access indicator for each entry limit 36. The calculating module 20 is then for example configured to position, at a prohibited access value, an access indicator associated with an entry limit 36 of a respective path 34, upon detection of a traffic element 18 positioned inside a detection zone Z associated with a path secant to said respective path.

In other words, once a traffic element 18 entering a respective detection zone Z is detected by the detection module 14, said detection being sent by the detection module 14 to the calculating module 20, the calculating module 20 then positions, at the prohibited access value, the access indicator associated with the entry limit(s) 36 of the or all of the paths 34 that are secant to the path 34 for which an entering traffic element 18 has been detected at its entry limit 36.

Each access indicator for example has a value equal to access prohibited or access authorized. When the access indicator may assume only these two values, its value is for example encoded in the form of a bit, with the value 0 corresponding by convention to access prohibited to the road intersection zone 12 and the value 1 corresponding to access authorized to the road intersection zone 12.

As an optional addition, each access indicator has more than two values and then has complementary values relative to the two aforementioned values, for example in order to inform the autonomous motor vehicle 24 of access authorized with restriction.

According to this optional addition, each access indicator has a value chosen from the group consisting of: access prohibited, access authorized, access authorized with a specific speed limitation, and access authorized with indication of a potential danger. The indication of a potential danger is for example an indication of work, an indication of a vehicle located on the shoulder, etc. One skilled in the art will then understand that in this example, the access authorized value, without additional precision, corresponds to access authorized with no special restrictions, i.e., without any restrictions other than those inherent to the code of the road in the country in question.

As an optional addition, the computing module 20 is further configured to compute, for each access indicator having the access prohibited value, a respective time delay. The duration of this time delay is for example a predefined value, such as a value of between 10 seconds and 2 minutes.

According to this optional addition, the calculation of the time delay associated with each access indicator having the prohibited access value makes it possible to balance the stop times of the autonomous motor vehicles 24 at the entries of the road intersection zone 12, in particular when the density of the automobile traffic is high.

The transmission module 22 is configured to send at least one access indicator to an autonomous motor vehicle 24 approaching the road intersection zone 12.

The transmission module 22 is for example configured to group together the set of access indicator(s) in a common file, also called container, and to broadcast said common file to the autonomous motor vehicle(s) 24 approaching the road intersection zone 12.

This transmission of the access indicator(s) in a broadcast manner then makes it possible to facilitate the sending of the access indicators by the transmission module 22, each receiving autonomous motor vehicle 24 then being able to filter the information contained in the received common file, so as to take into account only the access indicator concerning it, i.e., the access indicator associated with the access path 34 on which it is located.

In a variant, the transmission module 22 is configured to send, in an individualized manner and to each autonomous motor vehicle 24 approaching the road intersection zone 12, the access indicator concerning it, i.e., the access indicator associated with the access path 34 on which said autonomous motor vehicle 24 is located.

The common file is for example according to the SPaT (Signal Phase and Timing) protocol.

Each autonomous motor vehicle 24 preferably has a level of automation greater than or equal to 3 on the scale of the International Organization of Motor Vehicle Manufacturers (OICA). The level of automation is then equal to 3, i.e., a conditional automation, or equal to 4, i.e., a high automation, or equal to 5, i.e., a full automation.

According to the OICA scale, level 3 for conditional automation corresponds to a level for which the driver does not need to perform continuous monitoring of the driving environment, while still having to be able to take back control of the autonomous motor vehicle 24. According to this level 3, a system for managing the autonomous driving, on board the autonomous motor vehicle 24, then performs the longitudinal and lateral driving in a defined usage case and is capable of recognizing its performance limits to then ask the driver to take back dynamic driving with a sufficient time margin.

The high level of automation 4 then corresponds to a level for which the driver is not required in a defined usage case. According to this level 4, the system for managing the autonomous driving, on board the autonomous motor vehicle 24, then performs the dynamic longitudinal and lateral driving in all situations in this defined usage case.

The full automation level 5 lastly corresponds to a level for which the system for managing the autonomous driving, on board the autonomous motor vehicle 24, performs the dynamic lateral and longitudinal driving in all situations encountered by the autonomous motor vehicle 24, throughout its entire journey. No driver is then required.

One skilled in the art will further understand that, according to the invention, an autonomous motor vehicle 24 approaching said road intersection zone 12 will be authorized to enter said road intersection zone 12 only if it has received an access indicator not having the prohibited access value.

The sending of the access indicator(s) to each autonomous motor vehicle 24 is for example done using a communication protocol according to the Wi-Fi standard and/or the LTE (Long Term Evolution) standard, or using the Ethernet protocol. The transceiver 32, associated with the transmission module 22 for the sending of these indicators in the form of radio waves, is then done similarly according to the Wi-Fi standard and/or the LTE standard. The transceiver 32 is more generally according to one or several medium- or long-distance radiocommunication standards, such as a radio communication standard allowing the sending of information over a distance greater than or equal to 50 m, preferably over a distance greater than or equal to 100 m.

Each access path 34 extends over an extension axis, and two access paths 34 are secant when their extension axes are in turn secant, i.e., intersect, or cross at a point. In other words, two secant access paths 34 cross one another.

Each entry limit 36 is also called entry border and then delimits an entry into the corresponding road intersection zone 12. Each entry limit 36 is also called access point, within the broad meaning of the concept of access point, and the entry limit 36 generally not being periodic, but rather in the form of a segment or a curve segment.

As an example, in FIG. 1, the access paths 34 that are secant to the access path 34 associated with the arrow F1 are the access paths 34 respectively associated with the arrows F2 and F4. The access paths 34 respectively associated with the arrows F1 and F3 are considered to be parallel to one another and are then not secant to one another. Likewise, the access paths 34 respectively associated with the arrows F2 and F4 are considered to be parallel to one another and are then not secant to one another.

The position of each entry limit 36, as well as, by way of optional addition, of each upstream limit 38, is for example defined by GPS (Global Positioning System) coordinates, such as the GPS coordinates of the ends of a corresponding segment, forming said limit 36, 38.

One skilled in the art will understand that the entry limit 36, shown in broken lines in FIG. 1 or in FIG. 2, and the upstream limit 38, shown in dotted lines in FIG. 1 or in FIG. 2, are each predefined limits, the position of which is known, but do not necessarily correspond to a marking on the ground on the roadway of the associated access path 34. The entry limit 36, as well as, by way of optional addition, the upstream limit 38, are then considered virtual limits.

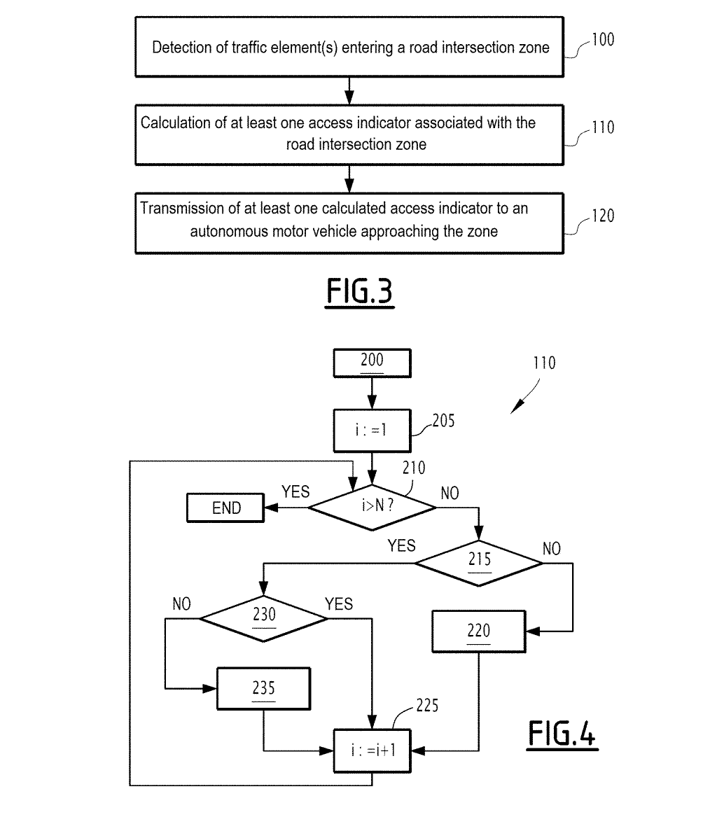

The operation of the electronic monitoring device 10 according to the invention will now be explained using FIG. 3 showing an organizational chart of the method, according to the invention, for monitoring the road intersection zone 12, the method being carried out by the electronic monitoring device 10.

During an initial step 100, the monitoring device 10 detects, via its detection module 14, the set of any traffic element(s) 18 entering the road intersection zone 12.

As previously indicated, this detection of any entering traffic element(s) 18 is done using one or more sensors 16 connected to the detection module 14, these sensors 16 being arranged on-street near the road intersection zone 12 and not being on board a respective autonomous motor vehicle 24.

During this detection step 100, the monitoring device 10 for example detects a traffic element 18 positioned inside the detection zone Z associated with a respective path 34 once a corresponding sensor 16 identifies a traffic element 18 on said path 34 positioned inside the detection zone Z, for example at most at the predefined distance D upstream from said entry limit 36, the traffic element 18 circulating from upstream to downstream on said path 34.

In the example of FIG. 1, the autonomous motor vehicle 24 moving along arrow F1 is in the process of crossing the entry limit 36 and positioned inside the detection zone Z associated with the path 34 on which it travels. It is then detected as a traffic element 18 entering the road intersection zone 12.

Conversely, the autonomous motor vehicle 24 moving along arrow F4 is not positioned inside the detection zone Z associated with the path 34 on which it travels, and in particular has not yet crossed the upstream limit 38 associated with the path 34 on which it travels. It is therefore not detected as a traffic element 18 entering the road intersection zone 12.

The monitoring device 10 next calculates, during the following step 110 and via its calculating module 20, at least one access indicator associated with the road intersection zone 12 as a function of the detection or non-detection, during the initial step 100, of traffic element(s) 18 entering the road intersection zone 12. This computation step 110 will be described in more detail below, in light of the flowchart in FIG. 4.

The monitoring device 10 lastly sends, during the following step 120 and via its transmission module 22, at least one access indicator to an autonomous motor vehicle 24 approaching the road intersection zone 12.

During this sending step 120, the transmission module 22 for example groups together the set of access indicator(s) in a corresponding common file, then broadcasts said common file to the autonomous motor vehicle(s) 24 approaching the road intersection zone 12, for effective and simplified sending of the access indicators.

The step 110 for calculating and sending the access indicators associated with the road intersection zone 12 will now be described in more detail in light of FIG. 4.

During a sub-step 200, the calculating module 20 receives, from the detection module 14, the set of any traffic element(s) 18 entering the road intersection zone 12, detected during the detection step 100.

This set of detected entering traffic element(s) 18 is for example sent in the form of a list, by the detection module 14, to the calculating module 20. One skilled in the art will of course understand that if no traffic element 18 entering the road intersection zone 12 has been detected during the detection step 100, then said set, or said list, is empty.

The calculating module 20 initializes, during sub-step 205, an entry limit index i at the value 1, the entry limit index i being an integer index with a value comprised between 1 and N, making it possible to identify each entry limit 36 from among the plurality of entry limits 36 associated with the road intersection zone 12. By convention, the entry limit index i is incremented by one unit from one entry limit 36 to the other. In the example of FIG. 1, the entry limit 36 associated with the arrow F1 is for example identified by the entry limit index i equal to 1, that associated with the arrow F2 by the entry limit index i equal to 2, and so forth. N represents the total number of entry limits 36 associated with the road intersection zone 12, and is for example equal to 4 in the example of FIG. 1.

The calculating module 20 tests, during sub-step 210, whether the value of the entry limit index i is strictly greater than N, in which case all of the entry limits 36 associated with the road intersection zone 12 have been taken into account, and the calculating step 110 is then complete.

Otherwise, i.e. if the value of the entry limit index i is less than or equal to N, then the calculating module 20 goes to sub-step 215, during which it determines, from the set, or list, received during sub-step 200, whether an entering traffic element 18 has been detected for the entry limit 36 with index i.

If no entering traffic element 18 has been detected for this entry limit 36 with index i, then during sub-step 220, the calculating module 20 positions each access indicator associated with an entry limit 36 of a path 34 that is secant to that for which no entering traffic element 18 has been detected at this entry limit 36 with index i, at the or one of the authorized access values. The calculating module 20 next increments, during sub-step 225, the value of the entry limit index i by one unit, before returning to sub-step 210 to test whether the value of the entry limit index i, incremented by one unit, is then strictly greater than N.

If, during sub-step 215, the calculating module 20 has on the contrary determined that at least one entering traffic element 18 has been detected for this entry limit 36 with index i, then the calculating module 20 goes to sub-step 230. During sub-step 230, it tests whether the value of the access indicator associated with this entry limit 36 with index i is equal to the access prohibited value.

If the value of the access indicator associated with this entry limit 36 with index i is equal to access prohibited, then the calculating module 20 goes to sub-step 225, during which it increments the value of the entry limit index i by one unit, before returning to sub-step 210.

If, on the contrary, the access indicator associated with this entry limit 36 with index i is equal to the or one of the access authorized values, and is therefore not equal to the access prohibited value, then the calculating module 20 goes to sub-step 235, during which it positions, at the access prohibited value, each access indicator associated with an entry limit 36 of a path 34 that is secant to that for which at least one entering traffic element 18 has been detected at this entry limit 36 with index i.

At the end of sub-step 235, the calculating module 20 goes to sub-step 225, during which it increments the value of the entry limit index i by one unit, before returning to sub-step 210.

The calculating step 110 ends when the value of the entry limit index i become strictly greater than N, following these successive incrementations by one unit during each iteration of sub-step 225.

In the example of FIG. 1, the autonomous motor vehicle 24 moving along arrow F1 is in the process of crossing the entry limit 36 and positioned inside the detection zone Z associated with the path 34 on which it travels. It is then detected as an entering traffic element 18 for the entry limit 36 with index i equal to 1. During the calculating step 110, during the first implantation of sub-step 215, the test is then positive, and the calculating module 20 therefore goes to sub-step 230, during which it determines that the value of the access indicator associated with this entry limit 36 with index 1 is equal to an access authorized value. Then, during sub-step 235, the calculating module 20 positions, at the access prohibited value, each access indicator associated with an entry limit 36 of a path 34 that is secant to that for which at least one entering traffic element 18 has been detected at this entry limit 36 with index 1. In other words, during sub-step 235, the calculating module 20 positions, at the access prohibited value, the access indicator associated with the entry limit 36 with index 2 (corresponding to arrow F2) and that associated with the entry limit 36 with index 4 (corresponding to arrow F4). The autonomous motor vehicle 24 moving along arrow F4, and approaching the entry limit 36 associated with the path 34 on which it travels, will thus receive, during the transmission step 120, the access indicator equal to access prohibited for this entry limit 36 with index i equal to 4. The autonomous motor vehicle 24 moving along arrow F4 will therefore stop before this entry limit 36 with index 4 associated with the path 34 on which it travels.

The monitoring of the road intersection zone 12 according to the invention then makes it possible to avoid a collision between the autonomous motor vehicle 24 moving along arrow F1, which has already entered the road intersection zone 12, and that moving along arrow F4 about to enter the road intersection zone 12, without having to use sensor(s) on board said autonomous motor vehicle(s) 24.

One can then see that the electronic device 10 according to the invention and the associated method for monitoring the road intersection zone 12 intended for autonomous motor vehicle(s) 24, make it possible, via less complex calculations, to further limit the collision risks inside the road intersection zone 12, while not requiring the implementation of sensor(s) on board said autonomous motor vehicle(s) 24.

1. An electronic device for monitoring a road intersection zone, the device comprising:
a detection module configured to detect, via at least one sensor, at least one traffic element entering the road intersection zone, each sensor being able to be connected to the detection module and being arranged on-street near said road intersection zone,
wherein the device further comprises:
a calculating module configured to calculate at least one access indicator associated with the road intersection zone as a function of the detection of traffic element(s) entering the road intersection zone,
a transmission module configured to send at least one calculated indicator to an autonomous motor vehicle approaching the road intersection zone.

2. The device according to claim 1, wherein the calculating module is configured to position each access indicator at an authorized access value as long as no traffic element entering the road intersection zone is detected.

3. The device according to claim 1, wherein the road intersection zone comprises several access paths, and each access path for motor vehicle(s), in particular for autonomous motor vehicle(s), is associated with a predefined entry limit into the road intersection zone, and
the calculating module is configured to calculate an access indicator for each entry limit.

4. The device according to claim 3, wherein the calculating module is configured to position, at a prohibited access value, an access indicator associated with an entry limit of a respective path upon detection of a traffic element positioned inside a detection zone associated with a path secant to said respective path.

5. The device according to claim 4, wherein the detection zone associated with a path is a predefined path in 2 or 3 dimensions.

6. The device according to claim 1, wherein the transmission module is configured to group together the set of calculated indicator(s) in a common file and to broadcast said common file to the autonomous motor vehicle(s) approaching the road intersection zone.

7. The device according to claim 1, wherein each access indicator has a value chosen from the group consisting of: access prohibited, access authorized, access authorized with a specific speed limitation, access authorized with indication of a potential danger.

8. The device according to claim 1, wherein each autonomous motor vehicle has a level of automation greater than or equal to 3 on the scale of the International Organization of Motor Vehicle Manufacturers.

9. A method for monitoring a road intersection zone, the method being carried out by an electronic monitoring device and comprising:
the detection, via at least one sensor, of at least one traffic element entering the road intersection zone, each sensor being able to be connected to the detection module and being arranged on-street near said road intersection zone,
wherein the method further comprises:
the calculation of at least one access indicator associated with the road intersection zone as a function of the detection of traffic element(s) entering the road intersection zone,
the transmission of at least one calculated indicator to an autonomous motor vehicle approaching the road intersection zone.

10. A non-transitory computer-readable medium comprising a computer program comprising software instructions which, when executed by a computer, carry out a method according to claim 9.

11. The device according to claim 5, wherein the detection zone associated with a path is in the shape of a polygon.
